(19) United States
(12) Patent Application Publication
(10) Pub. No.: US 2010/0021005 A1
(43) Pub. Date: Jan. 28, 2010

(54) Time Managing Device of a Computer System and Related Method

(76) Inventors: Li-Hsuan Chen, Taipei Hsien (TW); Hung-Young Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/205,910

(22) Filed: Sep. 7, 2008

(30) Foreign Application Priority Data
Jul. 24, 2008 (TW) 097128109

(51) Int. Cl. G06K 9/00

(52) U.S. Cl. 382/103

(57) ABSTRACT

A time managing device of a computer system including a graphic user interface capable of displaying application windows is disclosed. The time managing device includes an image capturing device, a sight-light detecting unit and a reminding unit. The image capturing device is used for capturing a user image corresponding to a user. The sight-light detecting unit is coupled to the image capturing device and used for analyzing a user sight-light state according to the user image to generate a sight-light detection result. The reminding unit is coupled to the sight-light detecting unit and the graphic user interface, and used for performing a reminder to a predetermined application window displayed on the graphic user interface according to a predetermined time and the sight-light detection result.

### BACKGROUND OF THE INVENTION

1. Field of the Invention

The present invention relates to a time managing device of a computer system and related method, and more particularly, to a time managing device of a computer system for managing a user's operation time and related method.

2. Description of the Prior Art

While using computers, most of computer users encounter the following two situations. In the first situation, the users open a couple of application windows at the same time. The types of those application windows may be diverse, such as a working management type (e.g. Microsoft Office, Professional Software, Outlook), an entertainment type (e.g. Instant Messenger, Games, Emails), and an information search type (e.g. Databases). The users could be distracted by too many application windows such that it is hard to manage their time properly. Thus, the users possibly spend more time on the application windows corresponding to trivial matters than on the application windows corresponding to main office work, thereby decreasing working efficiency. In the second situation, the users concentrate working on certain application window overtime. In a long term, it will be harmful to users' health.

The users usually get into the abovementioned situations unconsciously, but not intentionally. Therefore, managing working time appropriately can help the users enhance their work efficiency and stay healthy.

### SUMMARY OF THE INVENTION

It is therefore an objective of the present invention to provide a time managing device of a computer system and related method for reminding users of operation time.

The present invention discloses a time managing device of a computer system. The computer system includes a graphic user interface which is capable of displaying application windows. The time managing device includes an image capturing device, a sight-light detection unit and a reminding unit. The image capturing device is utilized for capturing a user image corresponding to a user. The sight-light detecting unit is coupled to the image capturing device and utilized for analyzing a user sight-light state according to the user image and generate a sight-light detection result. The reminding unit is coupled to the sight-light detecting unit and the graphic user interface, and used for performing a reminder to a predetermined application window displayed on the graphic user interface according to a predetermined time and the sight-light detection result.

The present invention further discloses a time managing method of a computer system including a graphic user interface capable of displaying application windows. The time managing method includes capturing a user image by use of an image capturing device, analyzing a user sight-light state to generate a detection result according to the user image, and then performing a reminder to a predetermined application window displayed on the graphic user interface according to a predetermined time and the sight-light detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a time managing device of a computer system according to an embodiment of the present invention.

FIG. 2 is a schematic diagram of the setting interface in FIG. 1 according to an embodiment of the present invention.

FIG. 3 is a flow chart of a time managing process of a computer system according to an embodiment of the present invention.

### DETAILED DESCRIPTION

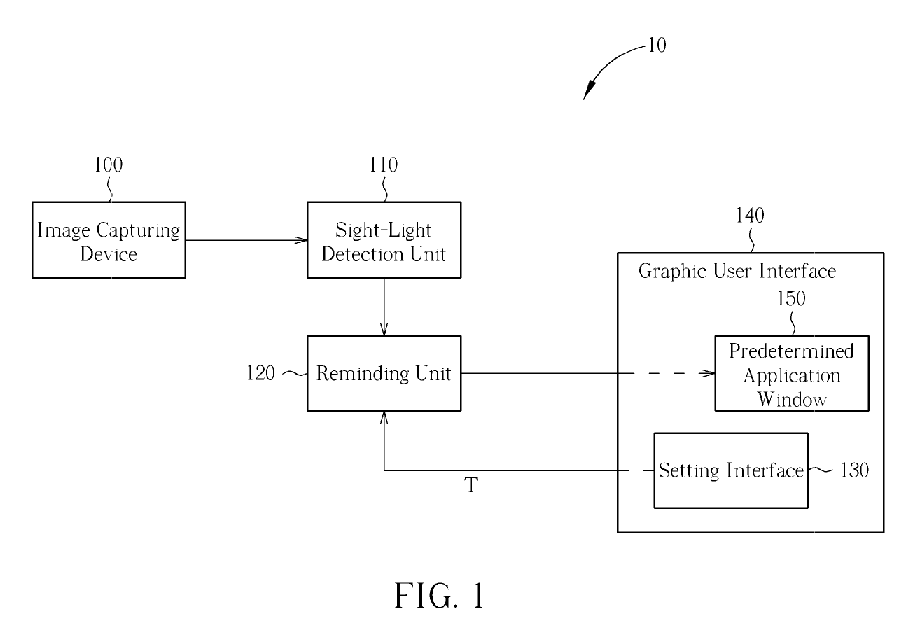

Please refer to FIG. 1, which is a schematic diagram of a time managing device 10 of a computer system. The time managing device 10 includes an image capturing device 100, a sight-light detection unit 110, a reminding unit 120 and a setting interface 130. The computer system includes a graphic user interface 140 for displaying an application window corresponding to the application programs. The graphic user interface 140 could be a graphic user interface of Microsoft, LINUX, Mac and other operating systems. The image capturing device 100 is preferably a web camera for capturing a user image, including a facial image of the user. The sight-light detection unit 110 is couple to the image capturing device 100 and used for analyzing a user sight-light state to generate a sight-light detection result according to the user image. The reminding unit 120 is coupled to the sight-light detection unit 110 and the graphic user interface 140 and used for performing a reminder to a predetermined application window 1 50 of the application windows displayed on the graphic user interface 140 according to a predetermined time T and the sight-light detection result.

Preferably, the sight-light detection unit 110 analyzes an open-close state, which indicates that user's eyes are open or closed, according the facial part of the user image to know whether the user keeps working on that computer system or not. The sight-light detection unit 110 can detect the number of times that the eyes has opened or shut within the predetermined time T. When the sight-light detection result reveals that the open-close state has stayed open for the predetermined time T, this means the user has been working on the computer system for a while. In this situation, the reminding unit 120 performs the reminder to the predetermined application window 1 50.

In order not to interrupt the user's operation, such as typing or mouse clicking, the reminder can be realized by expanding or shrinking the predetermine application window 150 with time or adjusting brightness of the predetermined window 150. For example, when the user types on the predetermined application window 150, the user still can keep typing without any interruption in spite of the predetermined application window 150 getting bigger at the reminding time. Thus the time managing device 10 can effectively remind the user of operation time duration without any interruption by properly predetermining the maximum size, the minimum size, the maximum brightness and the minimum brightness of the predetermined application window.

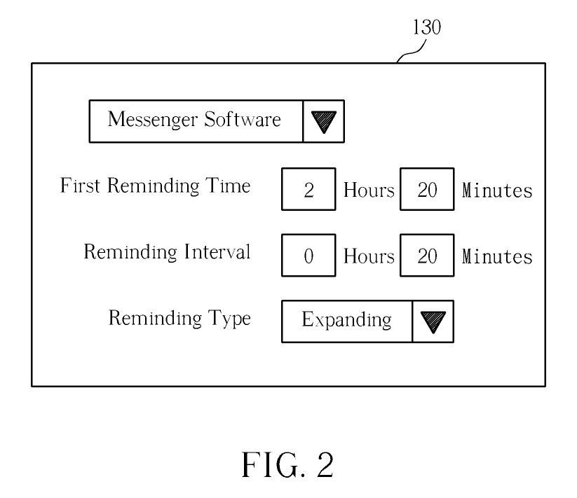

Besides, the setting interface 130, displayed on the user graphic interface 140, allows the user to set the predetermined time T, select the predetermined application window 150, and a reminder type. Please refer to FIG. 2, which is a schematic diagram of the setting interface 130 in FIG. 1 according to an embodiment of the present invention. The setting interface 130 in FIG. 2 shows an application program “messenger software” corresponding to the predetermined application window 150, a first reminding time set to 2 hours and 20 minutes, a repeated reminding interval set to 20 minutes, and the reminder type set to an expanding window effect.

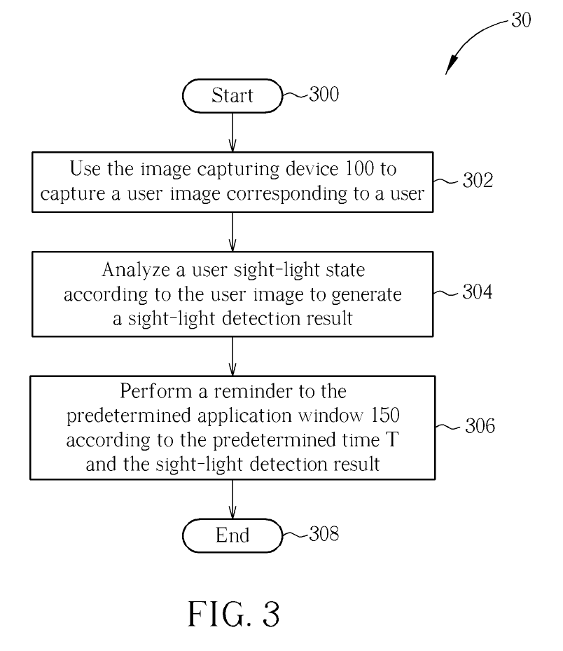

Please refer to FIG. 3, which is a flow chart of a time managing process 30 of a computer system according to an embodiment of the present invention. The time managing process 30 is applied to the time managing device 10 and includes the following steps:

Step 300: Start

Step 302: Use the image capturing device 100 to capture a user image corresponding to a user.

Step 304: Analyze a user sight-light state according to the user image to generate a sight-light detection result.

Step 306: Perform a reminder to the predetermined application window 150 according to the predetermined time T and the sight-light detection result.

Step 308: End.

According to the time managing process 30, the embodiment of the present invention obtains the user sight-light state within the predetermined time T by analyzing the captured user image to determine the operation duration and performs the reminder when the user has been working for a predetermined time T to prevent the user's eyes from being overused. The further detailed operations can be referred to the operations of the time managing device 10 since the time managing process 30 is applied to the time managing device 10.

Note that it is just an embodiment of the present invention to determine the operation duration by using the open-close state. The way to determine the sight-light state can also be determining the fixation location of the user's eyes, or determining the operation duration based on the other attributes of the eyes image in the user image.

In conclusion, the embodiment of the present invention obtains the operation duration that the user has been working for through the analysis of the user image captured by hardware equipments and achieves a purpose of time management by means of retaining the user's working state without interruption.

Those skilled in the art will readily observe that numerous modifications and alterations of the device and method may be made while retaining the teachings of the invention.

What is claimed is:

1. A time managing device of a computer system comprising a graphic user interface capable of displaying application windows, the time managing device comprising:
an image capturing device for capturing a user image corresponding to a user;
a sight-light detecting unit coupled to the image capturing device, for analyzing a user sight-light state according to the user image to generate a sight-light detection result; and
a reminding unit coupled to the sight-light detecting unit and the graphic user interface, for performing a reminder to a predetermined application window displayed on the graphic user interface according to a predetermined time and the sight-light detection result.

2. The time managing device of claim 1, wherein the image capturing device is a web camera.

3. The time managing device of claim 1, wherein the sigh-light detecting unit, according to the user image, analyzes an open-close state, which indicates that the user's eyes are open or closed, to generate the sight-light detection result.

4. The time managing device of claim 1, wherein the reminder varies a size of the predetermined application window with time.

5. The time managing device of claim 1, wherein the reminder adjusts brightness of the predetermined application window.

6. The time managing device of claim 1 further comprising a setting interface for setting the predetermine time and the predetermined application window.

7. A time managing method for a computer system comprising a graphic user interface capable of displaying application windows, the time managing method comprising:
utilizing a image capturing device to capture a user image corresponding to a user;
analyzing a user sight-light state according to the user image to generate a sight-light detection result; and
performing a reminder to a predetermined application window displayed on the graphic user interface according to the predetermined time and the sight-light detection result.

8. The time managing method of claim 7, wherein the image capturing device is a web camera.

9. The time managing method of claim 7, wherein analyzing the user sight-light state to generate the sight-light detection result according to the user image comprises analyzing an open-close state, which indicates that the user's eyes are open or closed, to generate the sight-light detection result according to the user image.

10. The time managing method of claim 9, wherein performing the reminder to the predetermined application window displayed on the graphic user interface according to the predetermined time and the sight-light detection result comprises performing the reminder to the predetermined application window displayed on the graphic user interface when the open-close state of the user indicates that the user's eyes keep opened for the predetermined time.

11. The time managing method of claim 7, wherein the reminder varies a size of the predetermined application window with time.

12. The time managing method of claim 7, wherein the reminder adjusts brightness of the predetermined application window.

13. The time managing method of claim 7 further comprising setting the predetermined time and the predetermined application window.
